(19) United States
(12) Patent Application Publication
(10) Pub. No.: US 2021/0380454 A1
(43) Pub. Date: Dec. 9, 2021

(54) METHOD AND APPARATUS FOR WATER TREATMENT

(71) Applicant: Jürgen Berthold, Eckental (DE)

(72) Inventors: Jürgen BERTHOLD, Eckental (DE); Hermann BERTHOLD, lgensdorf (DE)

(21) Appl. No.: 17/342,757

(22) Filed: Jun. 9, 2021

(30) Foreign Application Priority Data
Jun. 9, 2020 (DE) 10 2020 115 341.4

(51) Int. Cl. C02F 9/00

(52) U.S. Cl. CPC C02F 9/00; C02F 2301/046; C02F 2101/30; C02F 2303/24; C02F 2303/02

(57) ABSTRACT

A method for water treatment, wherein the water for treatment is conducted by a conveying device from an inlet to an outlet via multiple treatment stages, wherein
at least one of the treatment stages is an oxidation stage in which foreign matter situated in the water is oxidized by an oxidant which is added to the water in or upstream of the oxidation stage, and
at least one of the treatment stages to which the water is fed after the processing by the at least one oxidation stage is a separation stage in which foreign matter situated in the water after processing in the at least one oxidation stage is precipitated and separated off by addition of at least one separating agent, in particular of a flocculant and/or of activated carbon.

### CROSS-REFERENCE TO RELATED APPLICATIONS

The present application claims priority of DE 10 2020 115 341.4, filed Jun. 9, 2020, the priority of this application is hereby claimed, and this application is incorporated herein by reference.

### BACKGROUND OF THE INVENTION

The invention relates to a method and an apparatus for water treatment.

In many work and economic sectors, water is generated which is laden with particles, in particular with suspended matter or colloids. It is commonly sought for these particles, which may for example have sizes in the micrometer or nanometer range, to be separated off from the water. One major application for this is industrial water treatment, in order to purify water in a manner sufficient that it can be introduced into rivers, or the like. It is particularly advantageous if drinking water can be obtained directly from the industrial water. For this purpose, aside from filtering for the removal of relatively large items of suspended matter, use is made in particular of flocculation by addition of flocculants and subsequent sedimentation, or activated carbon may be added, in particular in order for odorous substances or flavoring agents and organic compounds to be adsorbed thereon.

A known problem here is that relatively high loads of organic molecules, in particular of relatively large organic molecules, in the water cannot themselves be flocculated, or can themselves be flocculated only very slowly, and can also disrupt the flocculation of other suspended matter. Furthermore, in particular, the removal of organometallic suspended matter is laborious. The stated problems lead to the relatively long processing times or standstill times for the water treatment, whereby high throughputs are possible only with very large treatment installations.

This is a problem in particular if it is the intention for water treatment to be performed locally for an individual facility or relatively small groups of users. For example, it may be desired to treat water which originates from a biogas plant and which is laden with fermentation waste, or which is otherwise laden with organic waste such as faeces, straw, grass etc. Water laden in this way is often also referred to generally as “slurry”. Even after relatively large contaminant items have been separated off, for example by pressing or filtering, a high load of large organic molecules and organometallic compounds remains in the water, resulting in the problems discussed above.

### SUMMARY OF THE INVENTION

The invention is thus based on the object of improving achievable throughputs in water treatment of a given size, or of allowing the use of a smaller apparatus that can nevertheless achieve good throughputs.

The object is achieved according to the invention by means of a method for water treatment, wherein the water for treatment is conducted by means of a conveying device from an inlet to an outlet via multiple treatment stages, wherein
at least one of the treatment stages is an oxidation stage in which foreign matter situated in the water is oxidized by means of an oxidant which is added to the water in or upstream of the oxidation stage, and
at least one of the treatment stages to which the water is fed after the processing by means of the at least one oxidation stage is a separation stage in which foreign matter situated in the water after processing in the at least one oxidation stage of the oxidation stage is precipitated and separated off by addition of at least one separating agent, in particular of a flocculant and/or of activated carbon.

The invention is based on the concept whereby the separation stage, in which a precipitation process known per se is performed by means of the separating agent, has positioned upstream of it an oxidation stage, in which at least proportions of the foreign matter situated in the water, in particular organic molecules, viruses, bacteria or other cell formations, and also fungi, germs, pesticides, herbicides and fungicides, are destroyed by oxidation. For this purpose, it is for example possible for potassium permanganate or hydrogen peroxide to be added as oxidant. By means of supportive measures discussed further below, it can be achieved that even relatively small quantities of oxidants are sufficient for a high throughput. In tests, the addition of a potassium permanganate solution with a mixture ratio of 1:1,000,000 was sufficient, wherein the potassium permanganate solution had a proportion by weight of potassium permanganate of 1%. It was furthermore identified that, even in the case of multiple oxidation stages being used, it is typically sufficient to add oxidant in the first of these oxidation stages because, in subsequent oxidation stages, oxidant that has not yet reacted can be used for the reaction.

The foreign matter separated off in the separation stage may thus, at least in part, be reaction products that result from oxidation of the foreign matter that was initially present. By virtue of the oxidation stage being positioned upstream, it is thus possible for the proportion of in particular large organic molecules and organometallic compounds in the at least one separation stage to be considerably reduced, whereby good treatment results can be achieved there even with relatively short standstill times and relatively little addition of separating agents. In one prototype, it was achieved, for example in conjunction with additional measures discussed in more detail further below, that an addition of 175 g of activated carbon and 175 g of flocculant is sufficient for the treatment of 1 m³ of water for purification, even if it is sought to treat heavily organically laden water, for example from a biogas plant.

As is apparent from the example above, it is possible in particular for a mixture of 50 wt % activated carbon and 50 wt % flocculant to be used as separating agent. This mixture ratio can however also be departed from as required. As flocculant, use is typically made of trivalent metal salts. Use may however also be made of other hydroxide-forming or organic flocculants.

The conveying device comprises, in particular, multiple line network sections that connect processing devices, which implement the individual treatment stages, to one another and/or to the inlet and/or outlet. In the individual line network sections, the transport of water can be implemented in each case by gravitational force or by means of a pump. The line network sections may furthermore, at least in part, comprise a controlled valve or else multiple controlled valves in order, for example in different sections of a processing cycle, to transport water from different sources and/or to different destinations. The conveying device or its components, that is to say in particular pumps and valves, and the processing devices that implement the individual treatment stages, may be controlled by means of a common control device.

It is advantageously possible that, in the oxidation stage or in at least one of the oxidation stages, an electrolysis of the water is performed by means of an electrolysis device. For this purpose, in a respective vessel in which the water is accommodated or which is flowed through by the water, there may be arranged electrodes, for example metal plates, to which a voltage is applied by means of an electrolysis device. In prototypes, good results were achieved with voltages in the range between 10 and 12 V. The electrode geometry was selected such that electrical currents of approximately 3 A result in the case of a typical salt content of the water in the respective oxidation stage. Here, the electrical current can in particular be measured in order to determine a salt content of the water. In order to avoid salt deposition on the electrodes, the polarity of the voltage, that is to say the positive and negative poles, may be switched at regular intervals, for example once per minute.

The electrolysis of the water results, at least locally in the region of the electrodes, in an increase in the concentration of H₃O⁺— and OH⁻ ions respectively. In this way, the activation energy for a hydrolysis of foreign matter is reduced, because the water does not need to be split in the course of this hydrolysis. In particular, the OH⁻ ions can contribute to an oxidization of organic molecules.

If a relatively high flow speed is utilized within the oxidation stage, such as may be the case for example when using the roll assembly discussed in more detail further below, the transport of said ions owing to the fluid flow can be considerably faster than diffusion processes, such that an elevated ion concentration can also be elevated in regions of an apparatus utilized for the oxidation that are at a relatively great distance from the electrodes.

Aside from the discussed increase in the ion concentration, the electrolysis furthermore results in high oxygen and/or ozone concentrations in the air above the water surface. The oxidation of foreign matter is thus further promoted at the water surface. This is relevant in particular if, in the course of the method, the surface area of the water is enlarged, for example by means of the roll assembly discussed in more detail further below.

It is preferable if a tenside is admixed to the water, in particular before said water is fed to the oxidation stage or to the oxidation stages. An addition of tensides to the water is in the first instance counterintuitive, because tensides have the effect in particular that non-polar molecules, that is to say in particular many organic molecules, can in the first instance be more easily dissolved in the water, which appears in the first instance to counteract a precipitation of such foreign matter. In the method according to the invention, the addition of a tenside is nevertheless advantageous.

As already discussed, some foreign matter cannot be directly precipitated out of the water, or can be precipitated out of the water only with relatively great material usage and/or long processing times, for which reason it is the intention in the method according to the invention for these, as discussed above, to initially be broken down by oxidation or hydration and for the residues of this breakdown to subsequently be precipitated. It is however a problem here that in particular hydrophobic foreign matter in water forms colloids of multiple molecules, such that a reaction for oxidation or hydration is possible for only those molecules which are situated directly at the surface of such a colloid. This on its own reduces the reaction rate.

A further exacerbating factor can be that colloids and other suspended matter may be surrounded by a hydrate shell, which further suppresses the reactions discussed above and thus further lengthens the processing time. Corresponding hydrate shells can, owing to the strong polarity of water molecules, form in the manner of clusters around ions or polar molecules. Even non-polar molecules or molecules with low polarity may however be surrounded by a hydrate shell. For example, the effect of water-avoiding hydration is known, in the case of which the mere presence of non-polar molecules or molecules with low polarity restricts the freedom of movement of the surrounding water and can thus lead to the formation of structures with a certain stability in the surrounding water.

Through the use of tensides, clusters of multiple molecules can be broken up, and the problem of hydrate shells can be reduced. The resulting separation of foreign matter in the water facilitates the oxidation and hydration of the foreign matter and thus the breakdown of the foreign matter into smaller components. Furthermore, by means of such a separation, a flocculation or a binding to activated carbon can also be accelerated, because the inhibitions of the reactions as discussed above are avoided. The discussed action of the tensides is particularly pronounced in the roll assembly, discussed in more detail further below, for surface area enlargement. Since the discussed effects however arise even if, for example, the water is at rest in a buffer vessel, or is agitated therein, for a certain period of time, it is advantageous for the tensides to be introduced into the water already at an early stage, for example immediately downstream of a separation, discussed in more detail further below, of solid matter by means of pressing processes, or if such pressing processes are not utilized, immediately downstream of the feed of water to a utilized apparatus for water treatment.

After the treatment of the water in the separation stage or at least one of the separation stages, a proportion of the water that contains an elevated concentration of precipitated foreign matter may be conducted by means of the conveying device back to the oxidation stage or to one of the oxidation stages. In this way, it is achieved in particular that the separating agent added in the separation stage, which separating agent may for example already be laden with foreign matter, is also introduced into the oxidation stage and can then be directly utilized for flocculating proportions of the foreign matter present there. Since the separating agent has already been utilized in the separation stage, it is however possible, for example, for relatively large flocculates to already be present, on which additional foreign matter can be adsorbed. By means of the described approach, the action of the added separating agent is thus improved, whereby material usage can be reduced. Furthermore, the use of the separating agent in the oxidation stage has the effect that relatively low foreign matter concentrations are already present in said oxidation stage and in subsequent oxidation stages, which can be advantageous with regard to the further treatment.

The separating-off of that proportion of the water which contains an elevated concentration of selected foreign matter can be implemented through the utilization of two outlet or extraction openings at different heights, wherein the treated water with relatively low foreign matter content is discharged via the higher opening, whereas the lower opening, which may be arranged for example at a base or within the lower 20 or 30% of the vessel height, can serve for discharging the sediment, that is to say water with a high content of precipitated foreign matter.

In the method according to the invention, in the oxidation stage or in at least one of the oxidation stages and/or in the separation stage or in at least one of the separation stages, the water may be held for a specified time interval in a respective buffer vessel before said water is conducted by means of the conveying device to a subsequent treatment stage. For flocculation or generally precipitation processes such as may be utilized in the separation stage or the separation stages and, as discussed above, optionally also in the oxidation stage or at least in parts of the oxidation stages, a continuous water flow is a problem. It may therefore be advantageous for at least parts of the treatment steps to be carried out in buffer vessels in which the water, after being introduced, is at rest for the specified time interval.

The time interval may be fixedly specified. For example, the water may be transferred onward in each case by one treatment stage in particular timing cycles. It is however also possible for the time interval to be specified in a manner dependent on measurement variables detected during the operation of the apparatus utilized for the treatment. For example, the time interval may be ended when a particular fill level of a particular vessel is reached, or the like.

In at least one of the buffer vessels, there may be arranged an agitator which is operated during a part of the time interval and which is at rest during a part of the time interval. By means of operation of the agitator, reaction processes in the buffer vessel, for example an oxidation or hydration of foreign matter or binding of foreign matter to tensides, activated carbon or other separating agents, can be accelerated. A situation in which the agitator is at rest serves in particular for enabling foreign matter that has bound to the or one of the separating agents to settle, such that they can for example be discharged from the respective buffer vessel at a base.

Downstream of the separation stage or downstream of one of the separation stages and upstream of the outlet, the water may be conducted through a fine filter with a pore size of between 50 μm and 0.5 μm or between 30 μm and 20 μm. In prototypes, fine filters with a pore size of 25 μm and 1 μm, for example, were tested with good success. By means of the fine filter, it is for example possible for very fine flocculates or very small activated carbon particles, for which a separation by means of the settling processes discussed above would take a relatively long time, to be retained, such that, in the separation stage or the separation stages and/or in the oxidation stage or the oxidation stages, if settling likewise occurs there, relatively short processing times can be utilized. For example, in prototypes, it was identified that a standstill time of the agitator of approximately 30 seconds can be sufficient in order, for example after operation of the agitator for 10 seconds, to achieve adequate settling of relatively large flocculates and activated carbon particles. Relatively small flocculates and the like can thus be separated off by means of the fine filter without this becoming quickly clogged up by large particles. By means of this combination, it is thus possible to achieve high water throughputs with relatively short processing times.

As the fine filter, use may be made of a cup-shaped fine filter which is arranged, in particular so as to be rotatable about a vertical axis, in a fine filter vessel, wherein the water from the separation stage or from at least one of the separation stages is fed to the fine filter via an open top side of the fine filter. By means of the described arrangement, it is possible, by means of the encircling side wall of the fine filter, to realize a large filter surface area, resulting in a high throughput and slow clogging of the fine filter.

The fine filter vessel may have multiple lateral openings to which water removed through the fine filter vessel can be fed by means of a pump in order to purge the fine filter. Here, the fine filter may in particular rotate, for example in a manner driven by a motor, in order to realize purging of the entire side wall of the fine filter through openings, for example nozzles, arranged at one side. Without such a purging process, progressive blockage of the pores of the fine filter would result over a relatively long period of operation of the apparatus utilized for carrying out the method. The purging thus leads, overall, to higher throughputs and longer maintenance intervals.

In order to achieve high effectiveness of this purging process, it is advantageous for the water to initially be substantially removed from the fine filter or fine filter vessel. In the simplest case, this would take place exclusively via the outlet. In one particularly advantageous refinement, however, a further evacuation may be performed by virtue of additional water being removed from the fine filter or the fine filter vessel in order to utilize said water for the pre-filling of a vessel, in particular of a buffer vessel, of an oxidation stage.

It is thus possible for a proportion of the water to be removed from the fine filter vessel or from the interior of the fine filter and fed to the oxidation stage or to at least one of the oxidation stages. In this way, firstly, the foreign matter concentration in said oxidation stage is lowered, which, in particular when using the roll assembly discussed in more detail further below, can lead to improved treatment of the foreign matter. At the same time, remaining foreign matter that accumulates in the fine filter itself, at a base, for example after a purging process can be removed through an extraction opening of the fine filter, whereby maintenance intervals and throughputs can be further improved. Furthermore, the removal of water from the fine filter vessel leads to a lowering of the water level therein, such that a greater proportion of the surface area of the fine filter can be purged.

Additional separating agent may be added to the water in the oxidation stage or in at least one of the oxidation stages by means of a dosing device. For this purpose, in particular, an additional separating agent reservoir may be used in which use may be made of the same separating agent, or the same mixture of separating agents, as that which is also used in the separation stage, or else of another separating agent or another separating agent mixture. The addition of additional separating agent may in particular be performed only when a utilized control device identifies, by means of a corresponding sensor arrangement, that higher separating agent concentrations are required. This may be expedient for example if it is identified on the basis of the electrode currents during electrolysis that the salt content in the water should be modified.

At least one of the treatment stages may be a pressing stage in which a pressing device is used in order to press the liquid through a filter device before said water is fed to the oxidation stage. For the separating-off of relatively coarse solid matter, use may be made of conventional presses, for example a screw press, which presses fed material against a screen, in order for the pressed water to subsequently be processed further as discussed above. If already only relatively small items of solid matter are present in the water, or if the pressing stage forms a second pressing stage downstream of the discussed course pressing, a fine press may be used in which use is made, for example, of a very small-pore filter nonwoven or the like. This will be discussed in more detail further below.

Separating agent may be added to the water in, or before said water reaches, the oxidation stage or at least one of the oxidation stages, wherein, after the treatment of the water in the respective oxidation stage, a proportion of the water that contains an elevated concentration of precipitated foreign matter is conducted by means of the conveying device back to the pressing stage or to one of the pressing stages. The addition of the separating agent may preferably be performed by virtue of a proportion of the water being recirculated from the separation stage to the oxidation stage or to a preceding oxidation stage, as discussed above. In addition or alternatively, the above-discussed addition of separating agent may be performed by means of a dosing device of the oxidation stage.

By means of the recirculation of the water that is heavily laden with foreign matter to the pressing stage, large flocculates and the like are separated off there as solid matter. Very small flocculates can continue to be utilized in the context of the flocculation. These are still small enough that they remain in the water after the pressing process and can thus be reused. By means of the described approach, the water treatment can be performed with very little material usage.

As the pressing stage or one of the pressing stages, use may be made of a filter press which has a housing to which the water is fed, wherein the pressing device is arranged in the housing and rotates about a vertical axis, wherein the pressing device has at least one pressing element which rotates about an axis of rotation which is at an angle with respect to the vertical axis, which pressing element is of circular cross section and has an outer shell formed from an elastic material, with which outer shell the pressing element rolls on the filter device, wherein the filter device comprises a filter medium and a filter plate which is positioned upstream of the filter medium and which has multiple apertures which are open toward the pressing element, wherein each of the apertures has a cross section which decreases toward the filter medium.

The filter press is distinguished by a pressing element that is rotatable about two axes. Firstly, the pressing element is rotatable about a central, vertically standing axis of rotation. Said pressing element extends away from the axis of rotation at an angle, such that said pressing element performs a 360° rotation during a rotation about the axis of rotation. Furthermore, the press device is itself rotatable about a second axis of rotation which is at an angle with respect to the vertical axis. This means that the pressing element, during a 360° rotation about the vertical axis, also rotates about itself several times.

The pressing element is itself circular, that is to say in the form of a roll, and has an outer shell composed of an elastic material. With this outer shell, said pressing element, during a 360° rotation, rolls on the filter device, wherein said pressing element lies with a corresponding pressure, that is to say in preloaded fashion, with the elastic outer shell against the filter device. The filter device itself has a filter medium which, by means of the diameter of the filter or screen openings, defines what maximum size a particle can have in order to pass through the filter medium, and what particles are retained. Said filter medium, which is for example a holed filter composed of a thin perforated metal filter sheet or a perforated, preferably tear-resistant plastics film, is assigned, upstream in the direction of the pressing element, a filter plate which has a multiplicity of apertures which are open toward the pressing element. The apertures change their cross section as viewed from the pressing element to the filter medium, wherein the aperture cross section decreases in said direction, that is to say the cross-sectional area decreases toward the filter medium.

If the press device now rotates about the vertical axis, then the press device, which hereby revolves, rolls with the elastic outer shell on the filter plate and, in so doing, rotates about itself. During this rotational movement, the elastic outer shell presses against the filter plate and, in so doing, is deformed. At the same time, the outer shell however also presses the particle-laden liquid into the apertures of the filter plate, which, as described, narrow toward the filter medium. In this way, and as a result of the fact that the outer shell is elastic, the pressure is progressively increased within the aperture that closes as it is rolled over, which has the effect that the liquid and fine particles passing through the filter medium are pressed through the filter medium, whilst at the same time relatively large particles in the aperture are retained by the filter medium. Owing to the pressure increase within the respective aperture, resulting from the fact that the elastic material is pressed into the aperture, the liquid is thus pressed out of the aperture. The separated-off particles are left behind. Accordingly, a filter cake composed of the compressed, separated-off particles is formed.

If the pressing element now rolls onward, then the aperture opens again. The pressed-out particles, or the filter cake, adhere(s) to the elastic outer shell and, as the pressing element rolls away, are carried along out of the aperture and moved out of the aperture, wherein this is assisted by the resulting decreasing pressure owing to the material that is moving away or being pulled out of the aperture. The compressed filter cake is thus automatically pulled out of or extracted from the aperture as the pressing element rolls away. As the pressing element moves onward, the filter cake detaches from the elastic outer shell and is suspended in the particle-laden liquid, wherein the filter cake, owing to its weight, sinks and passes to a collecting or accumulating region, from where it can then be drawn off as thick sludge. The filtered water that has been pressed through likewise accumulates in a corresponding accumulating region, from where it can be drawn off.

By means of the described refinement of the filter press, virtually continuous operation can be achieved, in the case of which the pressing of the water through the filter medium occurs at the same time as the self-cleaning of the filter device. This makes it possible for water laden with foreign matter to be continuously fed to the housing, and for the filtered water to be continuously drawn off. The remaining filter cake or thick sludge may be extracted, or removed in some other manner from the housing, selectively continuously or at particular times.

The respective pressing element may for example have a frustoconical shape. The filter device may also be frustoconical. An accumulator vessel for the pressed-through liquid may be connected downstream of the filter device. The filter device preferably has, centrally, an opening through which the vertical axis runs and through which, in particular, filter cakes composed of compressed particles can fall into an accumulating vessel.

In the or at least one of the oxidation stages, a roll assembly may be used for enlarging the surface area of the water, which roll assembly has at least one shaft bearing in each case at least one roll, a drive for the at least one shaft, a water feed arranged above the respective roll, and a collecting trough, assigned to the respective roll, for the water, wherein the roll has two cylinder-shell-shaped lateral surfaces which are spaced apart in a radial direction and which are each in the form of a mesh and which, at the bottom side of the roll, project into the collecting trough, wherein the water is conducted through the respective water feed to the respective roll, wherein the respective roll is driven by means of the drive.

In the roll assembly, the water flows, in particular via or through the lateral surfaces in the form of meshes, into the collecting trough, and is initially retained there. As a result of the rotation of the roll, depending on the water level in the collecting trough, one or both lateral surfaces in mesh form are led through the water and swirl or entrain said water. This results firstly in high dynamics or a turbulent flow between the lateral surfaces and thus good mixing, which can contribute to accelerating reactions for water treatment that take place in the water, for example a hydration of suspended matter. Furthermore, air from the surroundings of the roll is introduced into the water, which can firstly contribute to the oxidation of suspended matter and secondly leads to foam formation and thus to an enlargement of the surface area of the water, in particular if the water contains tensides or other foaming agents. In tests, for example for a water quantity of 2 l water, a foam volume of approximately 1 m³ briefly resulted, the surface area of which can be estimated as approximately 100,000 m².

It is essential here that the lateral surfaces in the form of meshes simultaneously act as foam breakers, whereby individual air bubbles of the foam typically have a lifetime of only a few ms, for example 1-2 ms. In order to achieve a rapid formation and a rapid breakdown of foam, rotational speeds of the shaft or shafts of greater than 100 rpm are preferably used. For example, rotational speeds between 300 rpm and 3000 rpm, in particular between 500 rpm and 2000 rpm, specifically between 800 rpm and 1200 rpm, for example a rotational speed of 1000 rpm, may be used.

As a result of the rapid formation and breakdown of foam, a high throughput can be achieved despite the large briefly provided surface area. In tests with a roll assembly with 6 shafts each bearing two rolls, with a structural space requirement of approximately 0.75 m³, it was possible to achieve a throughput of approximately 30,000 l/h.

In the context of water treatment, the guidance of the water through the roll assembly can serve in particular for initially producing a mixture with freely suspended matter, which can subsequently, in the downstream separation stage, be flocculated or bound to activated carbon, in order for them to be separated from the water by sedimentation. Here, numerous advantages are achieved by means of the approach described above. Thus, the foam formation or the formation of a very large water surface area has the effect that, during treatment of water, tensides at said surface form a type of filter surface, and colloids of hydrophobic matter or matter of low polarity can thus be broken up effectively by adsorption of said matter on the tensides. Here, the matter may be matter that was already present in the water previously, or in particular also matter that has formed during the course of preprocessing or even for the first time within the roll assembly by oxidation or hydration. Thus, in particular relatively large organic molecules, viruses, bacteria and the like are broken up by oxidation or hydration into relatively small components that can be bound to tensides, whereby flocculation is in turn made possible.

Furthermore, the highly dynamic, in particular turbulent, flow of the water in the region of the lateral surfaces, and in particular the rapid foam formation and destruction leads on the one hand to an acceleration of reactions in the water, that is to say in particular of the hydration of foreign matter by means of OH⁻ and H₃O⁺ radicals. As will be discussed in more detail further below, it is furthermore possible for air with a high oxygen or ozone content to be conducted into the roll region, which air can, owing to the large water surface area, contribute to the oxidation of foreign matter. Since the residues of corresponding reaction, if they are of low polarity, are bound by the filter surface of the tensides situated at the surface, as discussed above, said residues can be flocculated in an effective manner in a downstream step.

The exterior of the lateral surfaces may have a spacing of less than 3 mm or less than 2 mm or less than 1.5 mm to a base of the collecting trough. This may in particular be a minimum spacing. The minimum spacing may be dependent on the rotational position of the shaft or roll. In this case, the stated spacing may in particular be the minimum spacing that occurs during the course of the rotation of the roll. As will be discussed in more detail further below, it can be advantageous for the water treatment to utilize the smallest possible spacings between the lateral surface and the base of the collecting trough. For example, it is possible for the spacing to be between 1 mm and 1.2 mm or even less than 1 mm. For example, the spacing may be less than 0.5 mm or less than 0.3 mm. The spacing is preferably selected such that mechanical contact between the lateral surface and the base of the collecting trough during the operation of the roll assembly is avoided, because this would lead to wear of the components and, under some circumstances, to contamination of the water. The lower limit for the spacing is thus dependent on expected tolerances and on the stiffness of the mesh that forms the outer lateral surface.

For the treatment of water, certain reactions or interactions for foreign matter in the water should be brought about in a targeted manner, that is to say for example an interaction between foreign matter and tensides should be made possible, or an oxidation or hydration of the foreign matter should be made possible. These interactions can be impeded by a hydrate shell around the respective foreign matter. Corresponding hydrate shells can, owing to the strong polarity of water molecules, form in the manner of clusters around ions or polar molecules. Even non-polar molecules or molecules with low polarity may however be surrounded by a hydrate shell. For example, the effect of water-avoiding hydration is known, in the case of which the mere presence of non-polar molecules or molecules with low polarity restricts the freedom of movement of the surrounding water and can thus lead to the formation of structures with a certain stability in the surrounding water.

By means of a small minimum spacing between the outer lateral surface and the base of the collecting trough and the formation of the lateral surface as a mesh, water is conducted into said constriction by the rotation of the roll and is initially charged with intense pressure owing to the reduction of the spacing, and is subsequently rapidly expanded. This, and the shear forces that arise in the region of the constriction, can have the effect that hydrate shells of colloids or other foreign matter are broken up, such that these can for example be oxidized, hydrated or bound to tensides.

The oxidation stage that comprises the roll assembly may comprise a water vessel to which the water is fed via a vessel inlet and from which the water is discharged through a vessel outlet, wherein the water is drawn in via an intake opening of the water vessel, in particular by means of a pump, and fed to the respective water feed of the respective roll, wherein a water drain of the roll assembly, to which water that passes over a side wall of at least one of the collecting troughs is fed, opens out into the water vessel.

It is thus possible for water to be fed from the water vessel via the intake opening to the roll assembly or to the individual rolls, and, after treatment by means of the roll or rolls, the water can be conducted via the water outlet back into the water vessel. This makes it possible in particular that at least a proportion of the water situated in the water vessel passes multiple times through the roll assembly, whereby better purification can be achieved.

In particular, water can be fed continuously over a certain time interval via the vessel inlet, and substantially the same quantity of water can be discharged in this time interval via the vessel outlet. In particular, the water vessel may be situated in a flow path between two buffer vessels as discussed above, such that, at the end of the time interval in which the water remains in the first of said buffer vessels, the water is, for example by opening of a valve or by operation of a pump, conducted through the water vessel in order to reach the second buffer vessel. By means of suitable guidance of the water in the water vessel, it can be achieved in particular that, here, the water typically passes through the roll assembly at least once, in particular multiple times. As a result of the recirculation of the water from the roll assembly into the water vessel, the concentration of foreign matter for which treatment in the roll assembly is still desired would continuously decrease if it is initially assumed that no further water is fed via the vessel inlet and no water is discharged via the vessel outlet, because, in each case, a proportion of said foreign matter is conducted together with the water to the roll assembly and partially processed there. By coordination of the water quantity that is fed via the vessel inlet and discharged via the vessel outlet with the water quantity that is conducted via the intake opening to the roll assembly per unit of time, it is thus possible to set what remaining quantity of foreign matter is to be tolerated in the water that is discharged via the vessel outlet.

In order to improve mixing of the water recirculated from the roll assembly and the newly fed water, the water vessel may have a deflector plate which projects into the water vessel and ends freely in the water vessel. The vessel inlet and the water outlet of the roll assembly may be arranged on one side of the deflector plate, and the vessel outlet and/or the intake opening may be arranged on the opposite side of the deflector plate.

At least one gas feed line may open out in a housing of the roll assembly, which gas feed line is fed through a gas discharge opening at the top side of the water vessel. In particular, a foam breaker may be arranged at the gas discharge opening. This may be advantageous because foam can form on the water surface as a result of the operation of the roll assembly. This excessive foam would then be broken down by the foam breaker.

As already discussed above, an electrolysis of the water may be performed in the oxidation stages, in particular also in the water vessel. This has the effect inter alia that the air above the water surface in the water vessel has a high oxygen and ozone concentration. By means of at least one gas feed line, it can be achieved that this oxygen-rich and ozone-rich air can flow in a particularly effective manner into the region of the roll assembly, and/or is conveyed there in targeted fashion for example by means of a fan or the like. Since, however, the foam formation results in a very large water surface area there, foreign matter can thus be oxidized in an effective manner by means of the fed oxygen or the fed ozone.

Preferably, in the method according to the invention, at least two or at least three of the oxidation stages and/or at least two of the separation stages and/or at least two of the pressing stages are used, through which the water is conducted in each case sequentially by means of the conveying device. For example, a coarse press and a fine press are utilized as pressing stages, as discussed above. The oxidation stages and/or separation stages may each comprise a buffer vessel as discussed above, such that at least a major proportion of the water, at the end of the time interval for which it is received in the respective buffer vessel, is conducted to the next of the buffer vessels.

In at least one of the oxidation stages, in particular in the final oxidation stage, the above-discussed water vessel with the roll assembly arranged thereon may be connected downstream of the buffer vessel, such that the buffer vessel and the water vessel together form the final oxidation stage. In the course of the development of the method according to the invention and of the apparatus that carries out the method according to the invention, it was identified that, by means of multiple pressing, oxidation and separation stages that are passed through sequentially, it is possible, with the same use of structural space and energy consumption, to achieve a higher throughput than if, for example, respective stages of larger volume were used instead.

A proportion of the water from at least one of the oxidation stages may be recirculated into an oxidation stage that has been passed through previously. This may apply in particular for a final oxidation stage that comprises the roll assembly. In particular, here, a sediment that comprises precipitated foreign matter may be recirculated. As discussed above, separating agent is potentially already present in the water in the oxidation stages, such that, for example, oxidation products of foreign matter may also be precipitated in the oxidation stages. Furthermore, metal hydrides, the metals of which result from the oxidation of organometallic compounds, may for example also be precipitated. The precipitated particles are however very small, such that, firstly, it is scarcely possible for them to be separated off as solid matter by means of the pressing stages. Secondly, as a result of the recirculation to a preceding oxidation stage, said particles can serve for carrying out a further flocculation and thus obtaining larger flocculates, and at the same time further reducing material usage.

In the event of a triggering condition, which is in particular dependent on the water quality at the outlet, being satisfied, the inlet to a buffer vessel may be shut off, and instead water from a water reservoir may be processed. The buffer vessel may be arranged in the fluid path from the inlet to the outlet upstream of the oxidation stage, in particular between two pressing stages, specifically between a coarse press and a fine press, for example the filter press described above. The water reservoir may in particular be filled in advance with water that has passed through the separation stage or separation stages and in particular the fine filter. In other words, during normal operation, the water reservoir is filled with treated water, such that said water is available for processing in the event of the triggering condition being satisfied.

The triggering condition may be satisfied for example if the chemical oxygen demand (COD) at the outlet overshoots a threshold value. This indicates that insufficient treatment of the water has occurred, because a relatively large quantity of oxidizable matter remains in the water. This may under some circumstances result from the fact that contaminants have accumulated in the apparatus. Said contaminants can typically be removed again by means of operation with already-treated water for one or more cycles, such that, aside from a short interruption of the treatment operation in the event of the triggering condition being satisfied, there is typically no need for laborious maintenance.

The effectiveness of the discussed method will be presented briefly below on the basis of some information relating to a utilized prototype. All components of the prototype are accommodated in two 40-foot ISO containers. Despite these relatively compact dimensions and an energy consumption of only approximately 10 kW, it is possible, in the relatively laborious purification of fermentation residue of a biogas plant, to process approximately 18,000 tonnes of fermentation residue per year, resulting in over 12,000 tonnes of clear water. The nitrogen, phosphorus and all nutrient compounds are maintained in the solid matter (approximately 6000 t). Altogether, very good water treatment is thus achieved, with a high throughput in a relatively small structural space and with relatively little energy consumption.

Aside from the method according to the invention, the invention also relates to an apparatus for water treatment, comprising an inlet for the feed of water for treatment, an outlet for the discharge of treated water, and a conveying device for conveying the water from the inlet to the outlet, wherein the water is conducted through multiple treatment stages, wherein at least one of the treatment stages is an oxidation stage for the oxidation of foreign matter situated in the water by means of an oxidant which is added to the water in or upstream of the oxidation stage, and at least one of the treatment stages to which the water is fed after the processing by means of the oxidation stage is a separation stage for the precipitation of foreign matter situated in the water downstream of the oxidation stage, wherein a control device of the apparatus is configured for controlling the conveying device and the treatment stages. The apparatus may be configured for carrying out the method according to the invention for water treatment. In particular, the control device may be configured to control the conveying device and the treatment stages in order to carry out the method according to the invention. In general, features mentioned in relation to the method according to the invention may be transferred to the apparatus according to the invention for water treatment, and vice versa.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows an exemplary embodiment of an apparatus according to the invention for water treatment, by means of which an exemplary embodiment of the method according to the invention is implemented, and

FIGS. 2 to 4 show detail views of various components of the apparatus shown in FIG. 1.

### DETAILED DESCRIPTION OF THE INVENTION

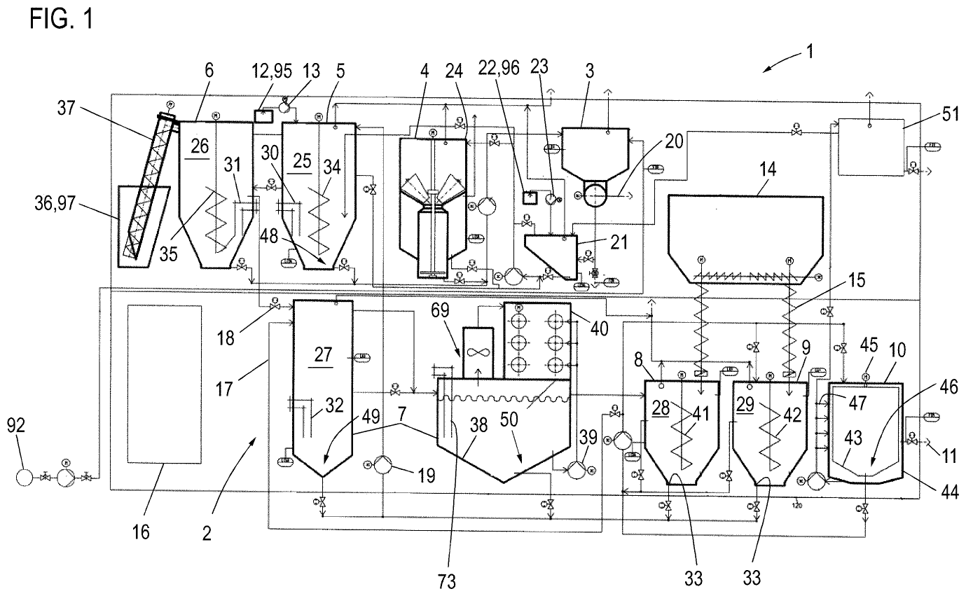

FIG. 1 shows an apparatus for water treatment 1, which apparatus comprises an inlet 92 for the feed of water for treatment, an outlet 11 for the discharge of treated water, and a conveying device 2 for conveying the water from the inlet 92 to the outlet 11, wherein the water is conducted through multiple treatment stages. Here, three of the treatment stages are oxidation stages 5, 6, 7, in which foreign matter situated in the water is oxidized by means of an oxidant 12 which is added to the water. By means of a dosing device 13, in the example a pump, the oxidant 12 is introduced from a reservoir into the water in the first oxidation stage 5, and also remains in said water in the subsequent oxidation stages 6, 7, such that oxidant that has not yet been consumed can also oxidize foreign matter in the further oxidation stages 6, 7.

The two treatment stages are separation stages 8, 9, to which the water is fed after said water has passed through the oxidation stages 5, 6, 7. In the separation stages 8, 9, separating agent 14, which may for example be a mixture of flocculant and activated carbon, is fed to the water from a reservoir by means of a respective dosing device 15, in the example by means of a conveying screw. This has the effect that foreign matter situated in the water flocculates owing to the flocculant, or are bound to the activated carbon.

Here, the problem commonly arises that high concentrations of large organic molecules can greatly inhibit such a physical separation by means of separating agents 14, such that a long standstill time and high material usage would be necessary in the separation stages 8, 9. In the apparatus 1 and in the discussed method, this is avoided in that, by means of the oxidation stages 5, 6, 7 that have been passed through beforehand, corresponding molecules have already been oxidized or destroyed in some other manner, such that primarily relatively small molecules, which can be easily precipitated, are present in the separation stages 8, 9.

The conveying device 2 serves for transporting the water between the inlet 92, the outlet 11 and the individual treatment stages. Said conveying device is formed by a multiplicity of line network sections 17, through which water is transported either by means of pumps 19 or by gravitational force. In order to prevent or enable transport by gravitational force, and/or for selection between multiple possible conveying paths, a multiplicity of valves 18 are also provided.

The pumps 19 and valves 18, like the various treatment stages, are controlled by means of a control device 16 of the apparatus 1, which control device is merely schematically illustrated. The control may be implemented for example by means of one or more microcontrollers, or the like. The provision of control signals and the receipt of sensor signals may take place directly digitally or by means of corresponding transducers.

If relatively large items of foreign matter are present in the fed water, for example long fibers, such as occur in slurry, fermentation residue from biogas plants or the like, it is advantageous to utilize at least one pressing stage 3, 4 as a further treatment stage upstream of the oxidation stages 5, 6, 7 in order to separate off solid and fibrous matter.

In the exemplary embodiment shown, as a first pressing stage 3, use is made of a coarse press which can for example press fed material against a screen by means of a screw, in order for the pressed water to subsequently be processed further. Here, as indicated by the arrow 20, the solid matter is conducted out of the apparatus 1 or is stored there until it is removed. The pressed water is firstly accumulated in a buffer vessel 21, wherein, in the buffer vessel 21, a tenside 22, in particular in the form of a tenside solution, is added from a reservoir 96 by means of the dosing device 23.

Tensides 22 lead in the first instance to better solubility of organic molecules, or of other molecules with low polarity, in water, such that an addition of tensides 22 for the purposes of improving a precipitation of foreign matter appears in the first instance to be counterintuitive. It has however been identified that, through addition of tensides, there is a tendency for a separation of foreign matter to be achieved, whereby reactions, that is to say in particular an oxidation or hydrolysis of said molecules, in order to split them up into smaller molecule residues, can take place considerably more quickly than in situations in which colloids, in particular of hydrophobic molecules, are present in clustered form as suspended particles, or the like.

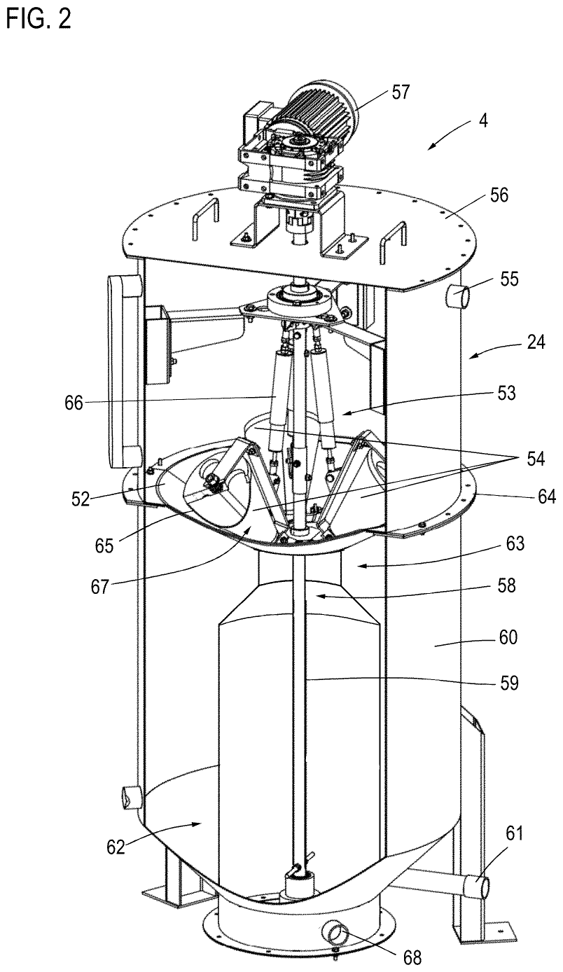

From the buffer vessel 21, the water with added tensides 22 is conducted into the housing 24 of a second pressing stage 4, which will be discussed in more detail further below with reference to FIG. 2. This can allow filtering of particles up to a size of between 1 μm and 50 μm, preferably up to a size of between 1 μm and 25 μm. By means of the refinement discussed in more detail further below, it is nevertheless possible for clogging of the filter to be avoided even in the case of water that is heavily laden with suspended matter.

The water purified by means of the two pressing stages 3, 4 is conducted into the buffer vessel 25 of the first oxidation stage 5, in the example by means of the same pump that has already been used to conduct the water to the second pressing stage 4. In said buffer vessel, as discussed above, oxidant 12 is added from the vessel 95. The water remains in the buffer vessel 25 for a certain time interval specified by the control device 16, wherein, for a part of this time interval, the agitator 34 is operated in order to accelerate reactions in the water.

Further to the addition of oxidant 12, a breakdown of in particular organic molecules is also realized by virtue of an electrolysis of the water in the buffer vessel 25 being performed by means of an electrolysis device 30, of which only the electrodes are illustrated schematically in FIG. 1. In this way, the ozone and oxygen content of the water and of the surrounding air increase, which on its own contributes to the oxidation of foreign matter. Furthermore, there are resulting elevated OH⁻ and H₃O⁺ concentrations at least in the immediate vicinity of the electrodes, whereby the hydrolysis of foreign matter can be accelerated, because, for this, no activation energy for the breakdown of water molecules is required.

Aside from the water fed from the pressing stage 4, water from the separation stages 8, 9 is also fed to the oxidation stage 5. Since said water is extracted via intake openings 33 that are arranged at or close to the base of the respective buffer vessel 28, 29, said water comprises a high concentration of foreign matter, which has been precipitated in the separation stage, and of the one or more separating agents, on which the foreign matter has been adsorbed. This results in numerous advantages. Firstly, in this way, separating agent is additionally already introduced into the first oxidation stage 5, such that foreign matter that has bound to corresponding separating agents can be precipitated already in the oxidation stage 5 and can be extracted via the extraction opening 48 in the vicinity of the base of the buffer vessel 25. For this purpose, the agitator 34 is deactivated for a part of the time interval for which the water remains in the buffer vessel 25. For example, the agitator 34 may be active for 10 seconds and may subsequently remain at rest for 30 seconds in order to allow a sedimentation of foreign matter that has bound to separating agents 14. Through the multiple use of the one or more separating agents 14, it is firstly the case that the required material usage is reduced. Secondly, it is for example the case that the flocculation in a respective separation stage 8, 9, on the one hand, and in the oxidation stage 5, on the other hand, results in relatively large flocculates, which can be separated off effectively by means of the pressing stage 3.

The water is subsequently conducted by means of the conveying device 2 into the buffer vessel 26 of the second oxidation stage 6. There, it is likewise the case that an electrolysis of the water is performed by means of the electrolysis device 31. Like the agitator 34, the agitator 35 is operated in a time-offset manner. Thus, substantially the same processes take place in the second oxidation stage 6 as in the oxidation stage 5. Through the addition of activated carbon and flocculants from the reservoir 97 by means of the dosing device 37 which is in the example in the form of a feed screw, the COD value of the water can be influenced and controlled, wherein the concentration of foreign matter, in particular of foreign matter that have still to be oxidized, is already reduced as a result of the preprocessing in the first oxidation stage 5. With sufficient addition of oxidants 12 from the vessel 95 in the first oxidation stage 5, there is still sufficient unconsumed oxidant 12 present, such that no further addition of oxidant is necessary.

Information regarding the salt content of the water in the buffer vessel 26 can be obtained from the electrical current flowing at the electrolysis device 31. In a manner dependent on said salt content or the electrical current, a dosing device 37, in the example a conveying screw, can be controlled by the control device 16 so as to introduce further separating agent 36 from a reservoir 97 into the water in the buffer vessel 26.

The third oxidation stage 7 is, by contrast, of somewhat different construction. There, use is likewise made of a buffer vessel 27, in which the water remains for a certain time interval in order to adapt the water treatment in said oxidation stage 7 to the cyclic passage of water through the other treatment stages. Furthermore, as discussed above, it is also the case in the buffer vessel 27 that an electrolysis is performed by means of the electrolysis device 32 in order to achieve the discussed advantages.

The buffer vessel 27 is however, in a preparatory manner, filled with water that is removed via an opening 46 at a base of a fine filter 43 which is arranged between the separation stages 8, 9 and the outlet 11. In other words, water that contains a low concentration of still-unprocessed foreign matter is used for the pre-filling of the buffer vessel 27. It has been found that, for the subsequent water treatment by means of the roll assembly 40, use is preferably made, already at the inlet side, of relatively low concentrations of foreign matter for processing.

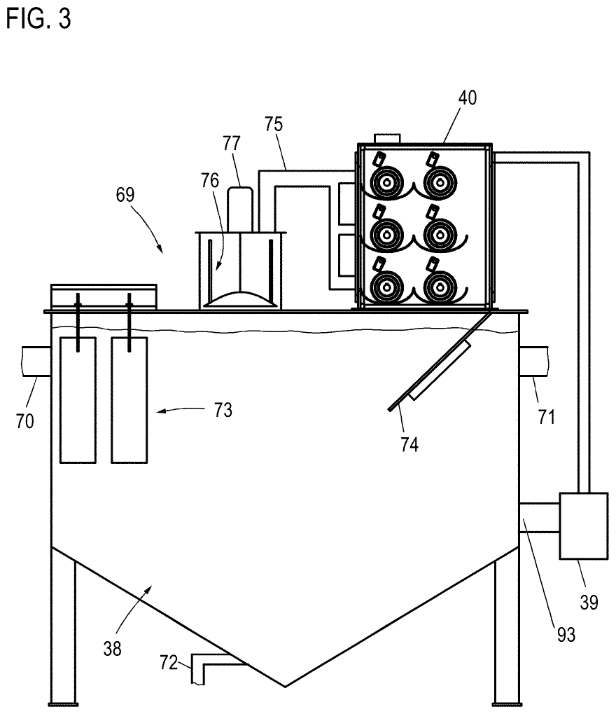

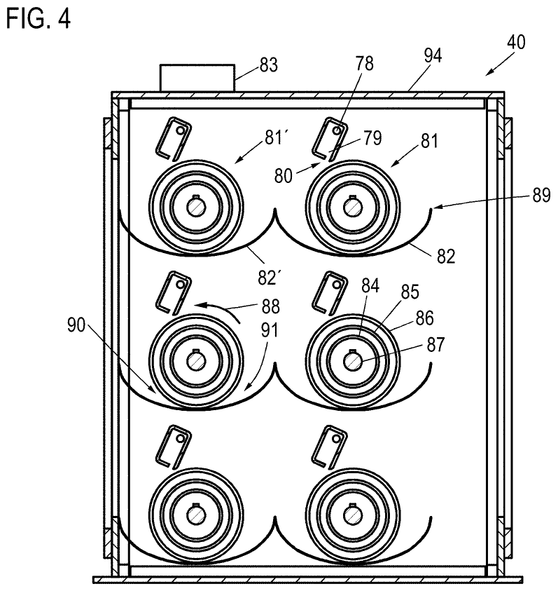

In the flow path between the buffer vessel 27 and the buffer filter 28 of the first separation stage 8, as part of the third oxidation stage 7, there is arranged a sub-stage 69, which will be discussed in more detail further below with regard to FIGS. 3 and 4. Said sub-stage serves generally for generating large water surface areas in a roll assembly 40 and, in this way, in particular in conjunction with the added tensides, achieving good molecule separation and thus very good reaction rates.

Since, as discussed above, owing to the recirculation of a proportion of the water from the separation stages 8, 9 into the oxidation stage 5, it is also the case in the oxidation stages 5, 6, 7 and thus also in the sub-stage 69 that the water contains separating agents 14 and, furthermore, certain residues of foreign matter precipitate of their own accord after an oxidation, for example hydroxides of metals which result in the case of an oxidation of organometallic compounds, extraction openings 49, 50 are arranged at the base on the buffer vessel 27 and on the water vessel 38 of the sub-stage 69, via which extraction openings water that comprises a high concentration of said precipitated foreign matter can be conducted back to the first oxidation stage 5, which can, as discussed above, result in relatively large flocculates, which can be separated out for example in the pressing stage 3.

After flowing through the sub-stage 69, the water is in turn accumulated in the buffer vessel 28, which is part of the separation stage 8, in which, as discussed above, additional separating agent 14 is fed from the reservoir. This results in a high separating agent concentration there and, after brief operation of the agitator 41, the latter can be stopped in order to realize a rapid precipitation of the foreign matter that has bound to the one or more separating agents 14.

The same approach is subsequently repeated in a further separation stage 9 in the buffer vessel 29, which has the agitator 42. Since the oxidation stages 5, 6, 7 used beforehand have already oxidized large organic molecules or destroyed these in some other way, there are no remaining obstructions to precipitation, such that, even with short standstill times of 30 seconds, for example, substantially complete precipitation of the foreign matter can be achieved.

In order to retain the few remaining foreign matter flocculates and activated carbon particles, which are relatively small and have thus not necessarily sunk, the water, after passing through the separation stages 8, 9, is conducted into a cup-shaped fine filter 43 which forms the final treatment stage 10 and which is mounted, so as to be rotatable by means of a motor 45, in a fine filter vessel 44. This may for example have a pore size of 25 μm, wherein use may also be made of considerably smaller pore sizes of for example 1 μm. The cup shape of the fine filter 43 results in a relatively large filter surface area, wherein, as a result of the rotation of the fine filter 43, different parts of said filter surface are primarily involved in the filtering process in alternating fashion, such that clogging of the filter surface takes considerably longer than in the case of a static filter.

Since such clogging can nevertheless not be completely avoided, purging of the fine filter 43 is performed after every cycle of the processing or after a certain number of cycles or the like. For this purpose, it is firstly the case that pure water is removed from the filter vessel 44 via the outlet 11, and at least a major proportion of the water that remains in the fine filter 43 is extracted via the opening 46 and, as already discussed above, is utilized to completely fill the buffer vessel 27. In this way, the side wall of the fine filter 43 is substantially completely exposed. Water removed from the fine filter vessel 44 can subsequently be fed through lateral openings 47 to the fine filter 43 by means of a pump, in order to purge the fine filter. Here, the fine filter 43 preferably rotates in order to achieve cleaning of substantially the entire surface area of the fine filter 43. Since, during the purging, the water passes through the fine filter 43 in the opposite direction to that during the filtering, the filter pores can be reliably opened again.

Over relatively long periods of operation of the apparatus 1, deposits may form on certain components of the apparatus 1, which deposits have the effect that increasingly larger proportions of the foreign matter or of decomposition products of the foreign matter reach the outlet. It can thus be expedient for the water quality at the outlet 11 to be periodically or continuously monitored, wherein it may suffice for samples to be taken at relatively large time intervals. If unsatisfactory water quality is detected, and if for example the COD value overshoots a threshold value, it would be possible, in principle, to perform maintenance of the apparatus 1 as a whole.

It has however been identified that, in many cases, it suffices to operate the apparatus 1 for one or more cycles with relatively clear water rather than with slurry or fermentation waste, for example, in order to achieve considerably improved levels of water quality at the outlet 11 during subsequent renewed operation with these starting materials. It is thus possible, in particular in automated fashion by means of the control device 16, for the inlet to the buffer vessel 21 to be shut off, and instead for water from a water reservoir 51 to be processed, in the event of a triggering condition being satisfied, for example in the event of an excessively high COD value being detected. As can be seen from the illustration in FIG. 1, the water in the water reservoir 51 may in particular be removed from the fine filter vessel 44 during the course of normal operation, that is to say may correspond to the treated water extracted via the outlet 11 during normal operation.

By means of the described construction of the apparatus 1 for water treatment and the described method, a very compact construction of the apparatus 1 is achieved. For example, the components shown can be arranged in two stacked 40-foot ISO containers, as is schematically illustrated in FIG. 1 by the boxes surrounding the components. This makes it possible for the apparatus to be delivered to an installation site with little outlay and to be set in operation there with little installation outlay by connecting a small number of lines. By means of the combination of oxidation and physical separation, in particular in conjunction with preceding pressing stages and a final stage of fine filtering, it is possible, with relatively low energy expenditure of 10 kW, for example, and by means of an apparatus of correspondingly small construction, to achieve relatively high throughputs of for example 18,000 tonnes of slurry per year. By means of the discussed multiple use of the separating agent and the use of the oxidant in multiple treatment stages, it is furthermore the case that very little usage of material is required.

FIG. 2 shows further details of the fine press used as pressing stage 4 in the apparatus 1. Here, the figure shows a cut-away perspective view. The treatment stage 4 comprises a housing 24, into which the water is introduced via an inlet 55. In the housing 24, there are arranged a fine filter device 52 and a pressing device 53, which, in the example shown, has three pressing elements 54. The housing 24 is closed off upwardly by means of a cover 56, on which there is seated a drive motor 57, which drive motor drives a shaft 59 which forms a vertical axis 58 and to which the pressing elements 54 are connected. The pressing elements 54 roll on the filter device 52 and press the water through the filter device 52, whilst a major proportion of the foreign matter, which has a certain particle size, remains stuck in the filter device 52. The purified water accumulates in an accumulating vessel 60, which is in the form of an annular space and which is positioned downstream of the filter device 52. Via an outlet 61, the filtered water can be drawn off and fed to the oxidation stage 5.

In the housing interior, there is furthermore provided an accumulating vessel 62, which is positioned downstream of a central opening 63 of the filter device 52. Pressed-out filter cakes accumulate in said accumulating vessel 62, which filter cakes are firstly formed in the filter device 52, by virtue of the pressing elements 54 rolling over the filter device 52, but are secondly also drawn out of the apertures of the filter device 52 again by means of said pressing elements, such that said filter cakes, suspended in the liquid, can accumulate in the accumulating vessel 62 and can be extracted therefrom via the extraction opening 68. In the apparatus shown in FIG. 1, the water extracted via the extraction opening 68 is fed to the first pressing stage 3.

The filter device 52 has a frustoconical or funnel shape and is screw-connected to the housing by way of the annular flange 64. The pressing elements 54 are of frustoconical form, such that they lie on the filter device 52. Each pressing element 54 comprises a hollow element body 65, to the outside of which an outer shell 67 composed of an elastic material is applied.

The filter device 52 comprises a filter plate which forms the apertures already discussed above, into which the filter cakes are pressed. At that side of the filter plate which is averted from the pressing elements 54, there is arranged a filter medium, for example a perforated film or a nonwoven, which has very small apertures, for example in the range between 1 μm and 25 μm. The filter medium retains the material of the filter cake and allows only water and very small particles to pass through.

By means of the approach discussed above, in which the filter cake is drawn out of the corresponding apertures again as the pressing elements 54 roll onward, it can be achieved that, in relation to conventional filters, in which the water is pressed through a filter medium, no or at least considerably fewer residues accumulate on the filter surface, whereby the corresponding pressing stage 4 can be operated over relatively long periods of time without maintenance, even if a very fine-pore filter medium is used.

FIG. 3 shows a detail view of the sub-stage 69 of the oxidation stage 7 shown in FIG. 1. Said sub-stage comprises a water vessel 38, to which water for processing is fed via a vessel inlet 70. After the processing, the water is discharged from the water vessel 38 via the vessel outlet 71.

In the exemplary embodiment, the water that flows in via the vessel inlet 70 firstly passes electrodes of an electrolysis device 73, to which electrodes a voltage is applied by means of said electrolysis device. The electrolysis of the water has the effect, on the one hand, that a high oxygen content and also a significant content of ozone or oxygen radicals are present in the air situated above the water surface, which, as will be discussed in more detail further below, can contribute to the breakdown of foreign matter in the roll assembly 40. Furthermore, at least locally in the region of the respective electrodes, a higher concentration of H3O+ and OH− radicals than would otherwise be present in the water is achieved. This can locally contribute to the hydration of foreign matter, because it is for example no longer necessary to separate a hydrogen atom from the water molecule in order to utilize an OH− group for the hydration of a molecule.

If the circulation of the water via the roll assembly 40, discussed in more detail further below, results in a flow speed that is sufficiently high, the elevated H3O+ and OH− concentrations can also be present in the roll assembly 40, because the transport of water can take place more quickly than a neutralization of H3O+ and OH− radicals by diffusion processes.

A deflector plate 74 is arranged in the water vessel 38 such that the vessel inlet 70 and a water outlet of the roll assembly 40, discussed again further below, are arranged on the same side of said deflector plate 74, whereas the vessel outlet 71 of the water vessel 38 is arranged on the other side of the deflector plate 74. This has the effect that water that is fed via the vessel inlet 70 cannot flow directly to the vessel outlet 71, but is mixed with the water that has already been treated in the roll assembly 40, whereby the concentration of still-unprocessed foreign matter in the water is considerably reduced.

Since the water mixed in this way is furthermore, on its flow path to the vessel outlet 71, conducted past an intake opening 93 via which it is drawn in by means of the pump 39 and conveyed to the roll assembly 40, it can be achieved, through corresponding setting of the conveying rate of the pump 39 in relation to the water quantity that is fed via the vessel inlet 70 and discharged by the vessel outlet 71, that fed water is, on average, conducted through the roll assembly 40 several times before being discharged via the vessel outlet 71. In this way, for the water in the water vessel 38 and in particular for the water that is discharged via the vessel outlet 71, a very low concentration of still-unprocessed foreign matter can be achieved.

The oxidation stage 7 or the sub-stage 69 serves primarily for processing foreign matter in the water such that said foreign matter can subsequently be precipitated in an effective manner in the separation stages 8, 9. Proportions of the foreign matter may nevertheless precipitate already in the sub-stage 69 itself. For example, in the case of the treatment of water that has been recovered from fermented slurry, for example from a biogas plant, relatively high pH values are encountered, such that, after a break-up of organometallic compounds, hydroxides of the metals are precipitated in most cases. Furthermore, as discussed above, it is also the case in the oxidation stages 5, 6, 7 that separating agents 14, 36 are already present in the water. A sediment with a high concentration of precipitated foreign matter can thus form in the water vessel 38, which sediment can be extracted via a pumping-out opening 50 situated close to the base, or the pipe 72.

In order to achieve high throughputs with relatively compact dimensions of the apparatus 1, on the one hand, and a low level of remaining unprocessed foreign matter in the water, on the other hand, the roll assembly 40 is utilized to enlarge the size of the surface area of the water and generally increase the dynamics of reactions for the treatment. A detailed view of the roll assembly 40 is illustrated in FIG. 4. In the example, the roll assembly 40 comprises six rolls 81, 81′, which are supported by a housing 94 of the roll assembly 40 and which are driven by a common drive 83. The drive 83 is merely schematically illustrated in FIG. 2. The drive 83 may for example be an electric motor. The drive 83 may for example be coupled directly to the shaft 87 of one of the rolls 81, 81′. The shafts 87 of the various rolls 81, 81′ may be coupled to one another in terms of movement, for example by means of V-belts.

The water that is drawn in by the pump 39 via the intake opening 93 is conducted to respective apertures 78 of the housing 94 of the roll assembly 40, which apertures are adjoined by water feeds 79 which conduct the inflowing water axially along the roll 81, 81′ and cause said water to flow through a gap 80 or some other opening onto an outer lateral surface 86 of the respective roll 81, 81′.

The respective rolls 81, 81′ comprise, as can be seen in particular in FIG. 4, two cylindrical lateral surfaces 85, 86 which are spaced apart from one another in a radial direction and which are each formed by a mesh. Below the roll 81, 81′, there is arranged a respective collecting trough 82, 82′ which collect the water fed via or by means of the roll 81, 81′. Here, the dimensions of the lateral surfaces 85, 86 are selected such that they project into the collecting trough 82, 82′ at the bottom side of the roll 81, 81′. Furthermore, radially within the inner lateral surface 85, there is situated a cylindrical inner shell 84, which is likewise connected rotationally conjointly to the shaft 87. As indicated by the arrow 88, the respective shaft 87 and thus the rolls 81, 81′ are rotated with a relatively high rotational speed of, for example, 1000 rpm.

The described arrangement has the effect that, in the case of the collecting trough 82, 82′ being filled to a sufficient level with water, the two lateral surfaces 85, 86 dip into the water and, owing to the lateral surfaces 85, 86 being in the form of meshes and owing to the relatively fast rotation of the rolls 81, 81′, intensely swirl said water and entrain said water at least over a certain distance. Thus, in the intermediate spaces between the lateral surfaces 85, 86 and between the inner shell 84 and the lateral surface 85, which may for example have an extent of 1 to 1.5 cm in a radial direction, there is resulting hydrodynamic water movement and swirling of the water. This leads, on the one hand, to an acceleration of treatment processes within the water, that is to say for example of a hydration of foreign matter.

On the other hand, in particular because tensides 22 are present in the water, there is resulting intense foam formation, wherein the lateral surfaces 85, 86 in the form of meshes however simultaneously act as mechanical foam breakers, such that the foam or individual air bubbles in the foam have a very short lifetime of for example only approximately 2 ms. The interaction of the intense foam formation with the simultaneous rapid breakdown of the foam has the effect that very large surface areas are briefly provided, but at the same time a high throughput can be achieved.

The formation of large surface areas leads on the one hand to foreign matter in the water interacting much more intensely with fed air, which, as discussed above, may in particular have high oxygen and ozone contents. On the other hand, tensides 22 present in the water are adsorbed on said surface and can thus form a large filter surface area in order at to kill foreign matter, for example organic residues of oxidized molecules or viruses or bacteria.

As a result of the rotation of the rolls 81, 81′, water situated in the respective collecting trough 82, 82′ tends to be accelerated to the right in FIG. 4, such that, for the collecting trough 82, the water is sloshed or conveyed over the side wall 89 of the collecting trough 82, following which said water can fall vertically through the cavity, situated to the right of the collecting troughs 82, of the housing 94 of the roll assembly 40, which cavity forms the water outlet of the roll assembly 40, back into the water vessel 38, specifically on the left-hand side of the deflector plate 74. This results in the mixing with freshly fed water, as already discussed above.

Here, water that is situated in the collecting trough 82′ is firstly conveyed into the collecting trough 82, because the side walls 89 of the collecting troughs 82, 82′ are connected to one another in water-tight fashion. This has the effect, on the one hand, that water that is initially fed to the rolls 81′ can be processed twice in the roll assembly, specifically once by the roll 81′ and once by the roll 81. At the same time, this has the effect that the water that is fed to the roll 81 is diluted with the pre-processed water fed from the roll 81′, such that a lower concentration of still-unprocessed foreign matter is present in the region of the roll 81 than is the case for the roll 81′. It has been identified that this combination between series and parallel processing of the water is particularly advantageous.

The mesh that forms the lateral surfaces 85, 86 may thus be designed so as to result in a sawtooth structure of the roll surface. This leads overall, in conjunction with a small spacing between the outer lateral surface 86 and the base of the collecting trough 82, 82′, to a good break-up of hydrate shells and water clusters, which can suppress a reaction of foreign matter in the water. The water is hereby initially intensely compressed in the region 90 and subsequently suddenly expanded in the region 91. Together with the shear forces that arise in the constriction, water clusters can be broken up in this way. A corresponding sawtooth structure for meshes results for example in the case of production of a rhomboidal mesh as an expanded mesh.

In order to firstly further assist the foam formation within the roll assembly and secondly achieve the high oxygen and ozone concentration, which occurs owing to the electrolysis of the water, also in the region of the rolls 81, 81′, use is made of gas feed lines 75 which are fed through a gas discharge opening at the top side of the water vessel 38. Since in particular the operation of the roll assembly 40 can have the effect that a foam layer forms on the surface of the water in the water vessel 38, and it is advantageously sought to prevent the gas discharge opening or the gas feed lines 75 from being covered with foam, which would restrict a feed of gas to the roll assembly 40, a foam breaker 76 is arranged in the region of the gas discharge opening, which foam breaker, in the example, is driven by an electric motor 77. As a foam breaker 76, use may for example be made of a disk with rods attached thereto, as is illustrated schematically in FIG. 3. Here, the rods are led rapidly through the foam and thus connect air bubbles, leading to the break-up of the foam. In addition or alternatively, baffle plates may be used, against which the air bubbles burst.

While specific embodiments of the invention have been shown and described in detail to illustrate the inventive principles, it will be understood that the invention may be embodied otherwise without departing from such principles.

We claim:

1. A method for water treatment, wherein the water for treatment is conducted by means of a conveying device from an inlet to an outlet via multiple treatment stages, wherein
at least one of the treatment stages is an oxidation stage in which foreign matter situated in the water is oxidized by means of an oxidant which is added to the water in or upstream of the oxidation stage, and
at least one of the treatment stages to which the water is fed after the processing by means of the at least one oxidation stage is a separation stage in which foreign matter situated in the water after processing in the at least one oxidation stage is precipitated and separated off by addition of at least one separating agent, in particular of a flocculant and/or of activated carbon.

2. The method according to claim 1, wherein, in the oxidation stage or in at least one of the oxidation stages, an electrolysis of the water is performed by means of an electrolysis device.

3. The method according to claim 1, wherein a tenside is admixed to the water, in particular before said water is fed to the oxidation stage or to the oxidation stages.

4. The method according to claim 1, wherein, after the treatment of the water in the separation stage or at least one of the separation stages, a proportion of the water that contains an elevated concentration of precipitated foreign matter is conducted by means of the conveying device back to the oxidation stage or to one of the oxidation stages.

5. The method according to claim 1, wherein, in the oxidation stage or in at least one of the oxidation stages and/or in the separation stage or in at least one of the separation stages, the water is held for a specified time interval in a respective buffer vessel before said water is conducted by means of the conveying device to a subsequent treatment stage.

6. The method according to claim 5, wherein, at least in one of the buffer vessels, there is arranged an agitator which is operated during a part of the time interval and which is at rest during a part of the time interval.

7. The method according to claim 1, wherein, downstream of the separation stage or one of the separation stages and upstream of the outlet, the water is conducted through a fine filter with a pore size of between 50 μm and 0.5 μm or between 30 μm and 20 μm.

8. The method according to claim 7, wherein, as a fine filter, use is made of a cup-shaped fine filter which is arranged, in particular so as to be rotatable about a vertical axis, in a fine filter vessel, wherein the water from the separation stage or from at least one of the separation stages is fed to the fine filter via an open top side of the fine filter.

9. The method according to claim 8, wherein the fine filter vessel has multiple lateral openings to which water extracted through the fine filter vessel is fed by means of a pump in order to purge the fine filter.

10. The method according to claim 1, wherein a proportion of the water is extracted from the fine filter vessel or from the interior space of the fine filter and fed to the oxidation stage or to at least one of the oxidation stages.

11. The method according to claim 1, wherein additional separating agent is added to the water in the oxidation stage or in at least one of the oxidation stages by means of a dosing device.

12. The method according to claim 1, wherein at least one of the treatment stages is a pressing stage in which a pressing device is used in order to press the water through a filter device before said water is fed to the oxidation stage.

13. The method according to claim 12, wherein separating agent is added to the water in, or before said water reaches, the oxidation stage or at least one of the oxidation stages, wherein, after the treatment of the water in the respective oxidation stage, a proportion of the water that contains an elevated concentration of precipitated foreign matter is conducted by means of the conveying device back to the pressing stage or to one of the pressing stages.

14. The method according to claim 12, wherein, as the pressing stage or one of the pressing stages, use is made of a filter press which has a housing to which the water is fed, wherein the pressing device is arranged in the housing and rotates about a vertical axis, wherein the pressing device has at least one pressing element which rotates about an axis of rotation which is at an angle with respect to the vertical axis, which pressing element is of circular cross section and has an outer shell formed from an elastic material, with which outer shell the pressing element rolls on the filter device, wherein the filter device comprises a filter medium and a filter plate which is positioned upstream of the filter medium and which has multiple apertures which are open toward the pressing element, wherein each of the apertures has a cross section which decreases toward the filter medium.

15. The method according to claim 1, wherein, in the or at least one of the oxidation stages, a roll assembly is used for enlarging the surface area of the water, which roll assembly has at least one shaft bearing in each case at least one roll, a drive for the at least one shaft, a water feed arranged above the respective roll, and a collecting trough, assigned to the respective roll, for the water, wherein the roll has two cylinder-shell-shaped lateral surfaces which are spaced apart in a radial direction and which are each in the form of a mesh and which, at the bottom side of the roll, project into the collecting trough, wherein the water is conducted through the respective water feed to the respective roll, wherein the respective roll is driven by means of the drive.

16. The method according to claim 15, wherein the oxidation stage that comprises the roll assembly comprises a water vessel to which the water is fed via a vessel inlet and from which the water is discharged through a vessel outlet, wherein the water is drawn in via an intake opening of the water vessel, in particular by means of a pump, and fed to the respective water feed of the respective roll, wherein a water drain of the roll assembly, to which water that passes over a side wall of at least one of the collecting troughs is fed, opens out in the water vessel.

17. The method according to claim 1, wherein at least two or at least three of the oxidation stages and/or at least two of the separation stages and/or at least two of the pressing stages are used, through which the water is conducted in each case sequentially by means of the conveying device.

18. The method according to claim 1, wherein a proportion of the water is recirculated from at least one of the oxidation stages into an oxidation stage that has been passed through previously.

19. The method according to claim 1, wherein, in the event of a triggering condition, which is in particular dependent on the water quality at the outlet, being satisfied, the inlet to a buffer vessel is shut off, and instead water from a water reservoir is processed.

20. An apparatus for water treatment, comprising an inlet for the feed of water for treatment, an outlet for the discharge of treated water, and a conveying device for conveying the water from the inlet to the outlet, wherein the fluid is conducted through multiple treatment stages, wherein at least one of the treatment stages is an oxidation stage for the oxidation of foreign matter situated in the water by means of an oxidant which is added to the water in or upstream of the oxidation stage, and at least one of the treatment stages to which the water is fed after the processing by means of the oxidation stage is a separation stage for the precipitation of foreign matter situated in the water downstream of the oxidation stage, wherein a control device of the apparatus is configured for controlling the conveying device and the treatment stages.
